(19) United States
(12) Patent Application Publication
(10) Pub. No.: US 2025/0106034 A1
(43) Pub. Date: Mar. 27, 2025

(54) SIDE CHANNEL ANALYSIS PROTECTED HMAC ARCHITECTURE

(71) Applicant: Microsoft Technology Licensing, LLC, Redmond, WA (US)

(72) Inventors: Mojtaba Bisheh Niasar, Ithaca, NY (US); Bharat S. Pillilli, El Dorado Hills, CA (US)

(21) Appl. No.: 18/373,126

(22) Filed: Sep. 26, 2023

(51) Int. Cl. H04L 9/32

(52) U.S. Cl. CPC H04L 9/3236

(57) ABSTRACT

Secure hash-based message authentication code (HMAC) deterministic random bit generator (DRBG) architectures are provided. A circuit can include HMAC DRBG circuitry including a counter configured to increment based on a clock state and provide a counter output, and HMAC function circuitry coupled to the HMAC DRBG circuitry, the HMAC function circuitry including first and second hashing circuits, the HMAC function circuitry configured to implement an HMAC function using the first and second hashing circuits and the counter output, the HMAC function circuitry configured to split a key into first and second shares based on the counter output and provide the first share to the first hashing circuit and the second share to the second hashing circuit.

### BACKGROUND

Cryptographic implementations are vulnerable to Side-Channel Analysis (SCA) attacks, which use some observable information from the device running an algorithm, such as timing, simple power analysis (SPA), differential power analysis (DPA), or electromagnetic information, to reveal a secret key. Countermeasures aim to reduce the correlation between the secret key and the side-channel measurement at the cost of adding resource overhead, latency overhead, or a combination thereof.

### SUMMARY

Circuits, devices, and methods provide SCA protection in a hash-based message authentication code (HMAC) deterministic random bit generator (DRBG) circuit. The circuits, devices, and methods are configurable to efficiently compute an HMAC while protecting the HMAC from SCA attacks.

A secure hash-based message authentication code (HMAC) deterministic random bit generator (DRBG) circuit can include HMAC DRBG circuitry. The HMAC DRBG circuitry can include a counter configured to increment based on a clock state and provide a counter output. The secure HMAC DRBG circuit can include HMAC function circuitry coupled to the HMAC DRBG circuitry. The HMAC function circuitry can include first and second hashing circuits. The HMAC function circuitry can be configured to implement an HMAC function using the first and second hashing circuits and the counter output. The HMAC function circuitry can be configured to split a key into first and second shares based on the counter output and provide the first share to the first hashing circuit and the second share to the second hashing circuit.

The HMAC DRBG circuit can include first linear feedback shift register (LFSR) coupled to receive a portion of the counter output as a seed value. The first hashing circuit can include a second LFSR. The second hashing circuit can include a third LFSR. The first and second LFSRs can be configured to receive respective portions of an output of the first LFSR. The second LFSR can be configured to receive most significant bits (MSBs) of the first LFSR and the third LFSR is configured to receive least significant bits (LSBs) of the first LFSR.

The HMAC DRBG circuitry can include multiple pins including a command pin coupled to circuitry that causes the HMAC DRBG to (i) ignore input on pins of the HMAC DRBG circuitry other than the command pin, in response to input on the command pin in a first state and (ii) ingest input on the pins other than the command pin in response to input on the command pin in a second, different state. The secure HMAC DRBG circuit can include an XOR gate coupled to an LFSR input pin of the multiple pins. The XOR gate can be situated to receive output of the counter and a linear feedback shift register (LFSR) initialization seed value as input when the input on the command pin in the second state. An entropy input pin of the multiple pins can be configured to receive an initialization vector and a nonce input pin of the multiple pins is configured to receive the output of the counter.

An XOR gate can be coupled to an LFSR input pin of the multiple pins. The XOR gate can be situated to receive output of the counter and a linear feedback shift register (LFSR) seed value as input when the input on the command pin in the second state. An entropy input pin of the multiple pins can be configured to receive a private key and a nonce input pin of the multiple pins is configured to receive a hashed message.

### BRIEF DESCRIPTION OF THE DRAWINGS

FIG. 1 illustrates, by way of example, a logical block diagram of an embodiment of a secured hash-based message authentication code (HMAC) deterministic random bit generator (DRBG).

FIG. 2 illustrates, by way of example, a flow diagram of an embodiment of implementing an HMAC function using multiple hashing circuits.

FIG. 3 illustrates, by way of example, a flow diagram of an embodiment of implementing an HMAC function using multiple hashing circuits when an input message has a size greater than a maximum size of input into the hashing circuits.

FIG. 4 illustrates, by way of example, a flow diagram of an embodiment of operating the HMAC DRBG circuit.

FIG. 5 illustrates, by way of example, a flow diagram of an embodiment of operating the HMAC DRBG circuit of FIG. 1.

FIG. 6 illustrates, by way of example, a diagram of an embodiment of a method for secure HMAC DRBG.

FIG. 7 is a block schematic diagram of a computer system that can include a secure HMAC DRBG, and for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Improved hash-based message authentication code (HMAC) deterministic random bit generator (DRBG) provided herein are secure from SCA attacks and also efficient. The secure HMAC DRBG is resistant against differential power analysis (DPA) and other SCA attacks. The HMAC DRBG implementations gives the tradeoff exploration between resource utilization and performance to implement an efficient HMAC DRBG from different optimization perspectives.

Implementations of the HMAC DRBG can be instantiated on an application specific integrated circuit (ASIC), field programmable gate array (FPGA), or other platform. An SCA protected HMAC DRBG architecture can include physical protection against SCA in modules vulnerable to SCA.

HMAC DRBG is a cryptographic random bit generator that uses a HMAC function. HMAC DRBG involves a cryptographic HMAC function and a seed. The HMAC DRBG architecture is specified in section 10.1.2. of National Institute of Technology (NIST) Special Publication (SP) 800-90A. Several cryptographic applications use an HMAC DRBG, such as an elliptic curve cryptography (ECC) signing operation. The nonce of the signing operation of deterministic elliptic curve digital signature algorithm (ECDSA) is described in section 3.1. of Request for Comment (RFC) 6979 is based on HMAC DRBG operation as specified in the NIST SP 800-90A.

HMAC DRBG uses a loop of HMAC functions, HMAC(K, V), to generate random bits. K is the key and V is the message being hashed. In an HMAC DRBG implementation, two constant values of K_init and V_init are used in the loop as follows:
1. Set V_init=0x01 0x01 0x01 . . . 0x01 (V has 384-bit)
2. Set K_init=0x00 0x00 0x00 . . . 0x00 (K has 384-bit)
3. cntr=0
4. K_tmp=HMAC(K_init, V_init∥cntr∥entropy∥nonce)
5. V_tmp=HMAC(K_tmp, V_init)
6. cntr=cntr+1
7. K_new=HMAC(K_tmp, V_tmp∥cntr∥entropy∥nonce)
8. V_new=HMAC(K_new, V_tmp)
9. Set T=[ ]
10.T=T∥HMAC(K_new, V_new)
11. Return T if T is within the [1,q−1] range, otherwise:
12. K_new=HMAC(K_new, V_new∥0x00)
13. V_new=HMAC(K_new, V_new)
14. Jump to 10

For more information on HMAC DRBG operations, see the NIST SP 800-90A.

As can be seen, HMAC DRBG takes two inputs, namely entropy and nonce, and generates a hashed message, T. A counter (entr) is internal to the HMAC DRBG and keeps track of the state of the HMAC DRBG.

The HMAC function of the HMAC DRBG is vulnerable to SCA. Secure HMAC DRBG is provided by altering operation of an underlying hashing algorithm. HMAC DRBG typically leverages a single secure hash algorithm (SHA) module to hash the message. The secure HMAC DRBG splits HMAC operations into multiple SHA modules. The key and the message are split into shares, most significant bits (MSBs) and least significant bits (LSBs). The multiple SHA modules and splitting of the key and message provides a masking countermeasure. The masking countermeasure makes electrical measurements provided by SCA uncorrelated with the key.

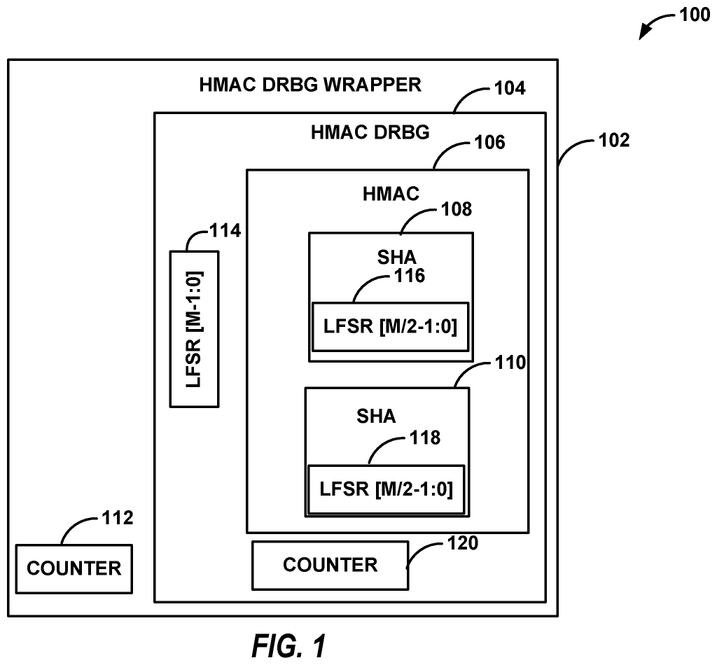

FIG. 1 illustrates, by way of example, a logical block diagram of an embodiment of a secured HMAC DRBG 100. The secured HMAC DRBG 100 includes an HMAC DRBG wrapper circuit 102, an HMAC DRBG circuit 104, an HMAC function circuit 106, and multiple hashing circuits 108, 110. The HMAC DRBG wrapper circuit 102 interfaces with components that access functionality of the HMAC DRBG circuit 104. The HMAC DRBG wrapper circuit 102 operates to count, by a counter 112, a number of random numbers generated by the HMAC DRBG wrapper circuit 102. The HMAC DRBG wrapper circuit 102 manages inputs to the HMAC DRBG circuit 104 and outputs from the HMAC DRBG circuit 104. The HMAC DRBG circuit 104 can receive an initialization vector (IV), a nonce, an entropy, a message, or the like that can be input into the HMAC DRBG circuit 104.

The HMAC DRBG circuit 104 generates a random number using an HMAC function implemented by the HMAC function circuitry 106. The HMAC DRBG circuit 104 operates to implement the HMAC DRBG algorithm described previously. The HMAC DRBG circuit 104 leverages a linear feedback shift register (LFSR) 114 to generate a random number that is used by the HMAC function circuit 106.

LFSR is a shift register whose input bit is a linear function of its previous state. The most commonly used linear function of single bits is exclusive-or (XOR). An LFSR is most often a shift register whose input bit is driven by the XOR of some bits of the overall shift register value. The initial value of the LFSR is called the seed, and because the operation of the register is deterministic, the stream of values produced by the register is completely determined by its current (or previous) state. Likewise, because the register has a finite number of possible states, it must eventually enter a repeating cycle. However, an LFSR can produce a sequence of bits that appears random and has a very long cycle.

The HMAC function circuit 106 includes multiple hashing circuits 108, 110. In the example of FIG. 1, the hashing circuits 108, 110 are SHA circuits, for example SHA512 circuits. The HMAC function circuit 106 implements a cryptographic authentication technique that uses a hash function and a secret key. The HMAC algorithm implemented by the HMAC function circuit 106 is as follows:
1. The key is fed to HMAC function circuit 106 to be padded in multiple ways resulting in key_ipad and key_opad.
2. The message is broken into chunks by the host,
   For each chunk:
   a. The chunk is fed to the HMAC function circuit 106,
   b. The HMAC circuit is triggered,
   c. The HMAC function circuit 106 is changed to ready after hash processing.
   d. The result can be read after feeding all message chunks.

Each of the hashing circuits 108, 110 includes its own LFSR 116, 118, respectively. Each of the LFSRs 116, 118 can produce the random bits used by the corresponding hashing circuits 108, 110. The HMAC function circuit 106 seeds the LFSR circuits 116, 118 with the hashing circuits 108, 110 to perform the HMAC function (HMAC (Key, message)) as follows: HMAC(K, message)=H(k_opad∥H(k_ipad∥message))

Where:
k_opad=K XOR [0x5c blockSize]
k_ipad=K XOR [0x36 blockSize]
and block size is 1024-bit for SHA512.

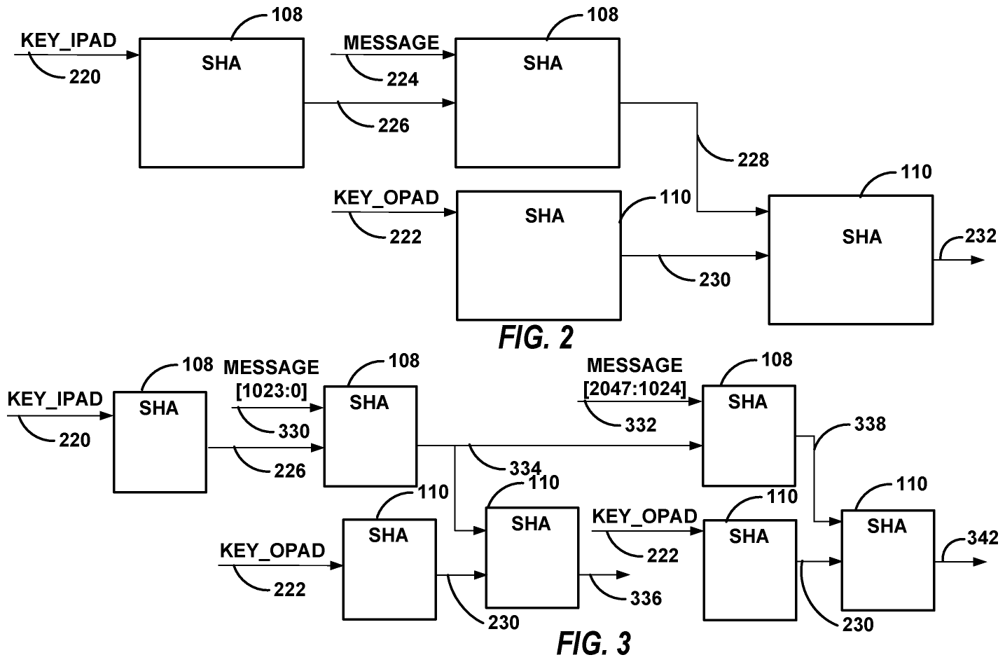

A concatenation operation (shown by ∥), allows the SHA512 operation to continue with feeding new input without resetting the previous results. More details regarding these operations are provided in FIGS. 2 and 3. The multiple hashing circuits 108, 110, the LFSRs 114, 116, 118, or a combination thereof, provide obfuscation of the key in that SCA analysis of the secure HMAC DRBG 100 is not correlated with the key.

FIG. 2 illustrates, by way of example, a flow diagram of an embodiment of implementing an HMAC function using multiple hashing circuits 108, 110. In FIG. 2, key_ipad 220 is input into the hashing circuit 108. A hash of the key_ipad 220 is determined by the hashing circuit 108 in a first cycle of operating the HMAC function circuit 106. A result 226 is the hash of the key_ipad 220. In a second cycle of operating the HMAC function circuit 106, hashing circuits 108, 110 both operate in parallel. Alternatively, the hashing circuit 110 can operate to determine the hash of the key_opad 222 in parallel with the hashing circuit 108 operation in the first cycle.

The hashing circuit 108 determines a hash of a message 224 concatenated with the hash of the key_ipad 220 (the result from the first cycle of operating the hashing circuit 108) to generate a result 228. A result 230 of hashing the key_opad 222 is concatenated with the result 228 and hashed by one of the hashing circuits 108, 110 in a third cycle. A result 232 is the HMAC function circuit 106 output for a message with a size than the block size operated on by the hashing circuits 108, 110. If the hashing circuits 108, 110 receive a message that is larger than their corresponding block size, more hashing circuit operations are performed to determine the HMAC function circuit 106 output.

FIG. 3 illustrates, by way of example, a flow diagram of an embodiment of implementing an HMAC function using multiple hashing circuits 108, 110 when an input message has a size greater than a block size of input into the hashing circuits 108, 110. The HMAC function of FIG. 3 begins similar to the HMAC function illustrated in FIG. 2, with LSBs 330 of a message, up to the block size of the input to the hashing circuits 108, 110, being fed into the hashing circuit 108 in a second cycle instead of the entire message 224. 1024 bits is the block size in the example of SHA 512 and FIG. 3, but other block sizes are possible.

A result 334 of hashing the LSBs 330 concatenated with the result 226 is provided to the hashing circuits 108, 110 for operation in a subsequent cycle. In a third cycle, the hashing circuit determines a result 336 that is a hash of the result 230 concatenated with the result 334.

Then a next chunk of the message 332 is processed in a similar manner as the previous chunk. In the example of FIG. 3, the result 334 is concatenated with the next chunk of the message 332. The concatenated data is hashed by the hashing circuit 108 to generate a result 338. The hash (result 222) of the key_opad 222 can be determined again by the hashing circuit 110 or the result 230 from previous operation can be reused. The hashing circuit 110 can determine a result 342 that is a hash of the results 338, 230 concatenated with each other. The result 342 is the HMAC of the message from which the chunks 330, 332 were determined.

The masking countermeasure of the FIGS. is embedded into an HMAC architecture. The masking countermeasure uses random values generated by the hashing circuits 108, 110 to conceal intermediate variables in the implementation of the HMAC function implemented by the HMAC function circuit 106, thereby making the side-channel leakage independent of the secret intermediate variables. To provide the required random values for masking intermediate values, LFSRs 114, 116, 118 are used. An LFSR is sufficient for masking statistical randomness.

Each round of SHA512 (512 bit SHA) execution uses 6,432 random bits. One HMAC operation implemented by the HMAC function circuit 106 uses at least four SHA512 operations (see FIG. 2). However, the proposed architecture of FIG. 1 requires only one M-bit LFSR seed (e.g., 148 bit in some instances) and provides first-order differential power analysis (DPA) attack protection at the cost of 10% latency overhead with negligible hardware resource overhead.

Most SCA attack countermeasures require several random vectors to randomize the intermediate values. The secure HMAC DRBG 100 can be utilized to take one random vector (e.g., of 384-bit), called an initialization vector (“IV”), and generates the random numbers (e.g., vectors of random numbers) for different countermeasures.

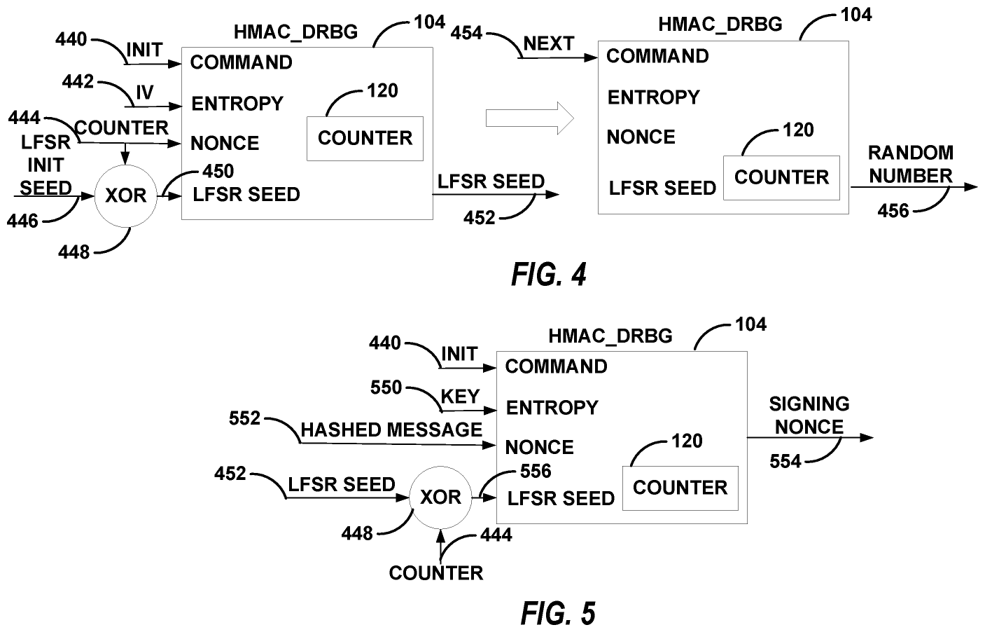

FIG. 4 illustrates, by way of example, a flow diagram of an embodiment of operating the HMAC DRBG circuit 104. In FIG. 4, secure HMAC DRBG circuit 104 is provided with initial input. The initial input includes an initialization command 440 provided into a command pin, an initialization vector (IV) 442 provided into an entropy pin, counter output 444 provided into a nonce pin, and a result 450 provided into an LFSR seed input. The result 450 is of an LFSR initialization seed 446 XORed (by XOR gate(s) 448) with output 444. The HMAC DRBG circuit 104 includes a counter 120 that keeps track of the number of results that have been provided since a last initialization command was received.

The initialization command 440 can cause the counter 120 to reset to zero. The HMAC DRBG circuit 104 can receive the result 450 and use it as an initialization value for the LFSR 114. The HMAC DRBG circuit 104 can implement the HMAC function circuitry 106 based on the initialization inputs to generate the LFSR seed 452. The LFSR seed 452 is not just the output of the LFSR in a next cycle of the LFSR 114.

The IV 442 and the LFSR initialization seed 446 can be from an external random number generator. The output 444 is from the counter 112. The counter 112 updates (e.g., increments) based on a state of a clock.

The HMAC DRBG circuit 104 can then be used to generate one or more further random numbers 456. The HMAC DRBG circuit 104 can, using the LFSR 114 and after a next clock trigger, generate a next random number internally, thus the result of the HMAC DRBG circuit 104 is different in each subsequent cycle. The internal random number is from the LFSR 114. The internal random number can be used by the HMAC function circuitry 106 to generate a random number 456. The random number 456 can be used, for example, for elliptic curve cryptography (ECC). The random number 456 can be used for point randomization, scalar blinding, an LFSR seed, or signature masking, for example. Random numbers can be generated for each use by changing the initialization command 440 to a next command 454.

The next command 454 causes the HMAC DRBG circuitry 104 to ignore the inputs and just operate the HMAC function circuitry 106 based on new values provided by the LFSRs 116, 118.

In a SCA random generator state for a signing operation of a deterministic elliptic curve digital signature algorithm (ECDSA), the HMAC DRBG circuitry 104 can generate four random vectors. The random vectors can be for (i) LFSR, (ii) base point randomization, (iii) scalar blinding, and (iv) masking signature randomization.

In sum, the HMAC DRBG circuitry 104 is initialized with the IV 442 input and an internal counter output 444. The counter 112 can be enabled after a reset and can provide different values depending on when the output 444 is retrieved. The HMAC DRBG circuitry 104 can be enabled by the INIT command 440. To generate all required random vectors, HMAC DRBG circuitry 104 will be continued by a NEXT command 454 that increments the built-in counter 120 of the HMAC DRBG circuitry 104. To initialize the seed for LFSR 114, LFSR INIT SEED 446 can be set as a constant, such as by logic circuitry, after reset/zeroize. However, this value can be updated before enabling HMAC DRBG circuitry 104 as follows: In the first execution of the HMAC DRBG circuitry 104 after reset, LFSR SEED input is equal to LFSR INIT SEED 446 XORed by the output 444 of the counter 112. In the next executions of the HMAC DRBG circuitry 104 that are for HMAC operation and not just for random number generation, the LFSR SEED input is set equal to HMAC DRBG circuitry 104 output (e.g., LFSR SEED 452 in the first execution cycle) of the first execution XORed by the output 444 of the counter 112. FIG. 5 shows the use of the HMAC DRBG circuitry 104 for generating a signing nonce 554.

FIG. 5 illustrates, by way of example, a flow diagram of an embodiment of operating the HMAC DRBG circuit 104. In FIG. 5, secure HMAC DRBG circuit 104 is provided with input for determining a signing nonce 554. The input includes an initialization command 440 provided into a command pin, a private key 550 provided into an entropy pin, a hashed message 552 provided into a nonce pin, and a result 556 provided into an LFSR seed pin. The result 556 is of the LFSR seed 452 XORed (by XOR gate(s) 448) with output 444. The LFSR seed 452 was generated in a prior execution of the HMAC DRBG circuitry 104.

The initialization command 440 can cause the counter 120 to reset to zero. The HMAC DRBG circuit 104 can receive the result 450 and use it as an initialization value for the LFSR 114. The HMAC DRBG circuit 104 can implement the HMAC function circuitry 106 based on the inputs on the pins to generate the signing nonce 554.

In an attack model, an attacker can form hypotheses about the secret key value and compute the corresponding output values by using the Hamming Distance model as an appropriate leakage model. Particularly, having the knowledge of details of the implementation for open-source architecture, this attack would be aided. The attacker can capture the power consumption traces to verify her hypotheses, by partitioning the acquisitions or using Pearson's correlation coefficient. The correlation, however, using the secure HMAC DRBG 100 the signals being monitored are not correlated with the secret key value.

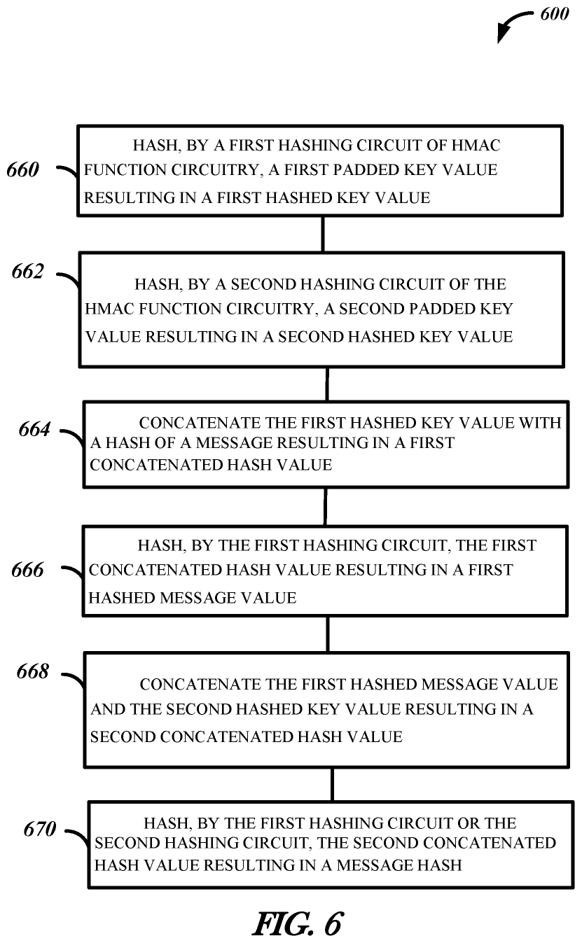

FIG. 6 illustrates, by way of example, a diagram of an embodiment of a method 600 for secure HMAC DRBG. The method 600 as illustrated includes hashing, by a first hashing circuit of HMAC function circuitry, a first padded key value resulting in a first hashed key value, at operation 660; hashing, by a second hashing circuit of the HMAC function circuitry, a second padded key value resulting in a second hashed key value, at operation 662; concatenating the first hashed key value with a hash of a message resulting in a first concatenated hash value, at operation 664; hashing, by the first hashing circuit, the first concatenated hash value resulting in a first hashed message value, at operation 666; concatenating the first hashed message value and the second hashed key value resulting in a second concatenated hash value, at operation 668; and hashing, by the first hashing circuit or the second hashing circuit, the second concatenated hash value resulting in a message hash, at operation 670.

The method 600 can further include receiving, from a first linear feedback shift register (LFSR) of the HMAC DRBG circuitry, an LFSR value. The method 600 can further include initializing a second LFSR of the first hashing circuit to most significant bits (MSBs) or least significant bits (LSBs) of the LFSR value. The method 600 can further include initializing a third LFSR of the second hashing circuit to LSBs or MSBs of the LFSR value, whichever is not used to initialize the second LFSR. The method 600 can further include ignoring input on other pins of the HMAC DRBG circuitry when input on a command pin is in a first state.

The method 600 can further include ingesting input on the other pins when input on the command pin is in a second, different state. The method 600 can further include initializing the first LFSR to an output of an XOR gate that is coupled to an LFSR input pin of the other pins and is situated to receive output of a counter of the HMAC DRBG circuitry and a linear feedback shift register (LFSR) initialization seed value as input when the input on the command pin in the second state. The method 600 can further include receiving, by an entropy input pin of the other pins, an initialization vector, and receiving, by a nonce input pin of the other pins, the output of the counter. The method 600 can further include initializing, by an XOR gate, input on an LFSR input pin, the XOR gate situated to receive output of a counter of the HMAC DRBG circuitry and a linear feedback shift register (LFSR) seed value as input when the input on the command pin in the second state.

The method 600 can further include receiving, by an entropy input pin of the other pins, a private key. The method 600 can further include receiving, by a nonce input pin of the other pins, a hashed message.

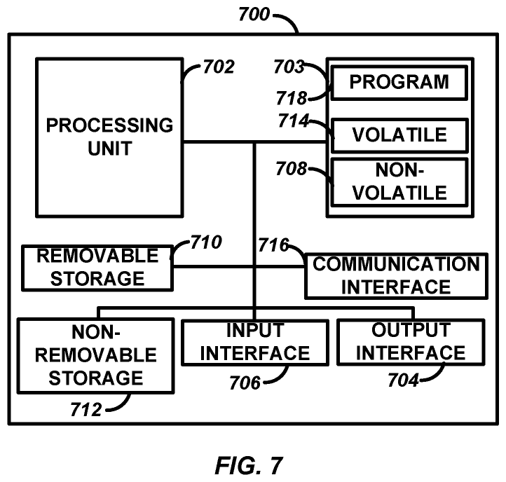

FIG. 7 is a block schematic diagram of a computer system 700 that can include a secure HMAC DRBG 100, and for performing methods and algorithms according to example embodiments. Any of the components of the secure HMAC DRBG 100 or other component can be implemented using the system 700 or a component thereof. All components of the system 700 need not be used in various embodiments, such as in FPGA implementation.

One example computing device in the form of a computer 700 may include a processing unit 702, memory 703, removable storage 710, and non-removable storage 712. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include-or have access to a computing environment that includes-a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

### NOTES AND ADDITIONAL EXAMPLES

Example 1 includes a secure hash-based message authentication code (HMAC) deterministic random bit generator (DRBG) circuit comprising HMAC DRBG circuitry including a counter configured to increment based on a clock state and provide a counter output, and HMAC function circuitry coupled to the HMAC DRBG circuitry, the HMAC function circuitry including first and second hashing circuits, the HMAC function circuitry configured to implement an HMAC function using the first and second hashing circuits and the counter output, the HMAC function circuitry configured to split a key into first and second shares based on the counter output and provide the first share to the first hashing circuit and the second share to the second hashing circuit.

In Example 2, Example 1 further includes, wherein the HMAC DRBG circuit further comprises a first linear feedback shift register (LFSR) coupled to receive a portion of the counter output as a seed value.

In Example 3, Example 2 further includes, wherein the first hashing circuit includes a second LFSR and the second hashing circuit includes a third LFSR, the first and second LFSRs configured to receive respective portions of an output of the first LFSR.

In Example 4, Example 3 further includes, wherein the second LFSR is configured to receive most significant bits (MSBs) of the first LFSR and the third LFSR is configured to receive least significant bits (LSBs) of the first LFSR.

In Example 5, at least one of Examples 1-4 further includes, wherein the HMAC DRBG circuitry further includes multiple pins including a command pin coupled to circuitry that causes the HMAC DRBG to (i) ignore input on pins of the HMAC DRBG circuitry other than the command pin, in response to input on the command pin in a first state and (ii) ingest input on the pins other than the command pin in response to input on the command pin in a second, different state.

In Example 6, Example 5 further includes an XOR gate coupled to an LFSR input pin of the multiple pins, the XOR gate situated to receive output of the counter and a linear feedback shift register (LFSR) initialization seed value as input when the input on the command pin in the second state.

In Example 7, Example 6 further includes, wherein an entropy input pin of the multiple pins is configured to receive an initialization vector and a nonce input pin of the multiple pins is configured to receive the output of the counter.

In Example 8, at least one of Examples 5-7 further includes an XOR gate coupled to an LFSR input pin of the multiple pins, the XOR gate situated to receive output of the counter and a linear feedback shift register (LFSR) seed value as input when the input on the command pin in the second state.

In Example 9, Example 8 further includes, wherein an entropy input pin of the multiple pins is configured to receive a private key and a nonce input pin of the multiple pins is configured to receive a hashed message.

Example 10 includes a secure hash-based message authentication code (HMAC) deterministic random bit generator (DRBG) method comprising hashing, by a first hashing circuit of HMAC function circuitry, a first padded key value resulting in a first hashed key value, hashing, by a second hashing circuit of the HMAC function circuitry, a second padded key value resulting in a second hashed key value, concatenating the first hashed key value with a hash of a message resulting in a first concatenated hash value, hashing, by the first hashing circuit, the first concatenated hash value resulting in a first hashed message value, concatenating the first hashed message value and the second hashed key value resulting in a second concatenated hash value, and hashing, by the first hashing circuit or the second hashing circuit, the second concatenated hash value resulting in a message hash.

In Example 11, Example 10 further includes receiving, from a first linear feedback shift register (LFSR) of the HMAC DRBG circuitry, an LFSR value.

In Example 12, Example 11 further includes initializing a second LFSR of the first hashing circuit to most significant bits (MSBs) or least significant bits (LSBs) of the LFSR value.

In Example 13, Example 12 further includes initializing a third LFSR of the second hashing circuit to LSBs or MSBs of the

LFSR value, whichever is not used to initialize the second LFSR.

In Example 14, at least one of Examples 10-13 further includes ignoring input on other pins of the HMAC DRBG circuitry when input on a command pin is in a first state.

In Example 15, Example 14 further includes ingesting input on the other pins when input on the command pin is in a second, different state.

In Example 16, Example 15 further includes initializing the first LFSR to an output of an XOR gate that is coupled to an LFSR input pin of the other pins and is situated to receive output of a counter of the HMAC DRBG circuitry and a linear feedback shift register (LFSR) initialization seed value as input when the input on the command pin in the second state.

In Example 17, Example 16 further includes receiving, by an entropy input pin of the other pins, an initialization vector, and receiving, by a nonce input pin of the other pins, the output of the counter.

In Example 18, at least one of Examples 15-17 further includes initializing, by an XOR gate, input on an LFSR input pin, the XOR gate situated to receive output of a counter of the HMAC DRBG circuitry and a linear feedback shift register (LFSR) seed value as input when the input on the command pin in the second state.

In Example 19, Example 18 further includes receiving, by an entropy input pin of the other pins, a private key, and receiving, by a nonce input pin of the other pins, a hashed message.

Example 20 includes a secure hash-based message authentication code (HMAC) deterministic random bit generator (DRBG) wrapper circuit comprising a first counter configured to provide a counter output, the first counter configured to increment based on a state of a clock, and HMAC DRBG circuitry including, a first linear feedback shift register (LFSR), and HMAC function circuitry including a first hashing circuit including a second LFSR situated to receive most significant bits (MSBs) of the LFSR as an initialization seed, including a second hashing circuit including a third LFSR situated to receive least significant bits (LSBs) of the LFSR as an initialization seed, and configured to, based on the counter output, generate an HMAC using the first and second hashing circuits.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A secure hash-based message authentication code (HMAC) deterministic random bit generator (DRBG) circuit comprising:
HMAC DRBG circuitry including a counter configured to increment based on a clock state and provide a counter output; and
HMAC function circuitry coupled to the HMAC DRBG circuitry, the HMAC function circuitry including first and second hashing circuits, the HMAC function circuitry configured to implement an HMAC function using the first and second hashing circuits and the counter output, the HMAC function circuitry configured to split a key into first and second shares based on the counter output and provide the first share to the first hashing circuit and the second share to the second hashing circuit.

2. The secure HMAC DRBG circuit of claim 1, wherein the HMAC DRBG circuit further comprises a first linear feedback shift register (LFSR) coupled to receive a portion of the counter output as a seed value.

3. The secure HMAC DRBG circuit of claim 2, wherein the first hashing circuit includes a second LFSR and the second hashing circuit includes a third LFSR, the first and second LFSRs configured to receive respective portions of an output of the first LFSR.

4. The secure HMAC DRBG circuit of claim 3, wherein the second LFSR is configured to receive most significant bits (MSBs) of the first LFSR and the third LFSR is configured to receive least significant bits (LSBs) of the first LFSR.

5. The secure HMAC DRBG circuit of claim 1, wherein the HMAC DRBG circuitry further includes multiple pins including a command pin coupled to circuitry that causes the HMAC DRBG to (i) ignore input on pins of the HMAC DRBG circuitry other than the command pin, in response to input on the command pin in a first state and (ii) ingest input on the pins other than the command pin in response to input on the command pin in a second, different state.

6. The secure HMAC DRBG circuit of claim 5, further comprising an XOR gate coupled to an LFSR input pin of the multiple pins, the XOR gate situated to receive output of the counter and a linear feedback shift register (LFSR) initialization seed value as input when the input on the command pin in the second state.

7. The secure HMAC DRBG circuit of claim 6, wherein an entropy input pin of the multiple pins is configured to receive an initialization vector and a nonce input pin of the multiple pins is configured to receive the output of the counter.

8. The secure HMAC DRBG circuit of claim 5, further comprising an XOR gate coupled to an LFSR input pin of the multiple pins, the XOR gate situated to receive output of the counter and a linear feedback shift register (LFSR) seed value as input when the input on the command pin in the second state.

9. The secure HMAC DRBG circuit of claim 8, wherein an entropy input pin of the multiple pins is configured to receive a private key and a nonce input pin of the multiple pins is configured to receive a hashed message.

10. A secure hash-based message authentication code (HMAC) deterministic random bit generator (DRBG) method comprising:
hashing, by a first hashing circuit of HMAC function circuitry, a first padded key value resulting in a first hashed key value;
hashing, by a second hashing circuit of the HMAC function circuitry, a second padded key value resulting in a second hashed key value;
concatenating the first hashed key value with a hash of a message resulting in a first concatenated hash value;
hashing, by the first hashing circuit, the first concatenated hash value resulting in a first hashed message value;
concatenating the first hashed message value and the second hashed key value resulting in a second concatenated hash value; and
hashing, by the first hashing circuit or the second hashing circuit, the second concatenated hash value resulting in a message hash.

11. The method of claim 10, further comprising receiving, from a first linear feedback shift register (LFSR) of the HMAC DRBG circuitry, an LFSR value.

12. The method of claim 11, further comprising:
initializing a second LFSR of the first hashing circuit to most significant bits (MSBs) or least significant bits (LSBs) of the LFSR value.

13. The method of claim 12, further comprising:
initializing a third LFSR of the second hashing circuit to LSBs or MSBs of the LFSR value, whichever is not used to initialize the second LFSR.

14. The method of claim 10, further comprising ignoring input on other pins of the HMAC DRBG circuitry when input on a command pin is in a first state.

15. The method of claim 14, further comprising ingesting input on the other pins when input on the command pin is in a second, different state.

16. The method of claim 15, further comprising initializing the first LFSR to an output of an XOR gate that is coupled to an LFSR input pin of the other pins and is situated to receive output of a counter of the HMAC DRBG circuitry and a linear feedback shift register (LFSR) initialization seed value as input when the input on the command pin in the second state.

17. The method of claim 16, further comprising:
receiving, by an entropy input pin of the other pins, an initialization vector; and
receiving, by a nonce input pin of the other pins, the output of the counter.

18. The method of claim 15, further comprising initializing, by an XOR gate, input on an LFSR input pin, the XOR gate situated to receive output of a counter of the HMAC DRBG circuitry and a linear feedback shift register (LFSR) seed value as input when the input on the command pin in the second state.

19. The method of claim 18, further comprising:
receiving, by an entropy input pin of the other pins, a private key; and
receiving, by a nonce input pin of the other pins, a hashed message.

20. A secure hash-based message authentication code (HMAC) deterministic random bit generator (DRBG) wrapper circuit comprising:
a first counter configured to provide a counter output, the first counter configured to increment based on a state of a clock; and
HMAC DRBG circuitry including:
a first linear feedback shift register (LFSR); and
HMAC function circuitry:
including a first hashing circuit including a second LFSR situated to receive most significant bits (MSBs) of the LFSR as an initialization seed;
including a second hashing circuit including a third LFSR situated to receive least significant bits (LSBs) of the LFSR as an initialization seed; and
configured to, based on the counter output, generate an HMAC using the first and second hashing circuits.
